(19) United States
(12) Patent Application Publication
(10) Pub. No.: US 2008/0195476 A1
(43) Pub. Date: Aug. 14, 2008

(54) Abandonment remarketing system

(76) Inventors: Michael A. Marchese, Chicago, IL (US); Michael S. Manley, Chicago, IL (US); Jason L. Wadler, Glencoe, IL (US); Dennis C. Corrigan, Jacksonville, FL (US)

Correspondence Address: BRINKS HOFER GILSON & LIONE, P.O. BOX 10395, CHICAGO, IL, 60610, US

(21) Appl. No.: 11/704,687

(22) Filed: Feb. 9, 2007

(51) Int. Cl. G06Q 30/00

(52) U.S. Cl. 705/14; 705/28

(57) ABSTRACT

An abandonment remarketing system streamlines the recovery of on-line abandoning consumers by financing incentives through other parties interested in conducting business with the abandoning consumer. The system may enhance the recovery of on-line abandoning consumers by offering an abandoning consumer an opportunity to receive an incentive redeemable with an abandoned on-line retailer while reducing or eliminating the cost of the incentive to the on-line retailer.

### TECHNICAL FIELD

This application relates to on-line marketing, and more particularly to an on-line abandonment remarketing system.

### BACKGROUND

On-line retail web sites lose thousands of prospective consumers each day. Some of these lost consumers may leave an on-line retail web site to comparison shop or because of confusion or frustration with the web site. These lost consumers may result in lost revenues for the on-line retailer. Increasingly, some on-line retailers are trying to recover these lost consumers.

Some on-line retailers offer consumers leaving a Web site a discount to return to the Web site and complete a transaction. This offer may require the on-line retailer to purchase the amount of the discount from their inventory. Accordingly, by making this, type of offer, the on-line retailer may be required to spend money up front to try and recover a lost consumer.

### SUMMARY

An abandonment remarketing system and method are disclosed that provide an incentive to a consumer leaving an on-line retailer's Web-based entity to return to the Web-based entity and reduces or eliminates the on-line retailer's cost to recover the leaving consumer. The system allows an on-line retailer to retain the business of some abandoning customers. The system permits a remarketing provider to provide an abandoning consumer with an incentive redeemable with an abandoned on-line retailer to entice the abandoning consumer to return to the abandoned on-line retailer and make a purchase. In order to receive the incentive, the abandoning consumer completes an action at an offer web site that may be unrelated to the on-line retailer's web site. After completing the action, the abandoning consumer may be re-directed back to the on-line retailer. The remarketing provider may purchase the incentive from the on-line retailer covering some or all of the on-line retailer's costs associated with recovering the abandoning consumer, and the remarketing provider may receive a referral payment from the offer site for referring a new consumer (e.g., the abandoning consumer).

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system and method may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a flow diagram of contracting for abandonment remarketing services.

FIG. 2 is a block diagram of an exemplary abandonment remarketing system.

FIG. 3 is a diagram of a memory space in an abandonment Web server

FIG. 4 is a flow diagram to retain on-line business.

FIG. 5 is a diagram of a first graphic interface of an on-line retailer.

FIG. 6 is a diagram of a second graphic interface of an on-line retailer.

FIG. 7 is a diagram of a third graphic interface of an on-line retailer.

FIG. 8 is a diagram of a graphic interface of an incentive offer.

FIG. 9 is a diagram of a graphic interface of an offer site.

### DETAILED DESCRIPTION

An online abandonment remarketing system stream lines the recovery of on-line abandoning consumers by financing incentives through other parties interested in conducting business with a consumer that abandons an on-line retailer. The system may enhance the recovery of on-line abandoning consumers by offering an abandoning consumer an opportunity to receive an incentive redeemable with an abandoned on-line retailer while reducing or eliminating the cost of the incentive to the on-line retailer.

Throughout this document, various terms are used. A consumer may be an individual or a representative of an organization using a Web browser (e.g., Internet Explorer, Netscape, Mozilla, Firefox, and/or Opera) to view or purchase products and/or services at an on-line retailer's Web site. An abandoning consumer may be a consumer that performs an action in a Web browser window causing the consumer to leave an on-line retailer's Web site. An on-line retailer may be an individual or an organization using the abandonment remarketing system that has products and/or services to sell to a consumer through a Web-based interface (e.g., on-line retail Web site). When a consumer abandons an on-line retailer's Web-based interface, the on-line retailer may become an abandoned on-line retailer. An eligible Web page may be a Web page associated with an on-line retailer whose source code may include a reference to an abandonment offer file and one or more abandonment logic files, which may be stored on an abandonment server. An offer site provider may be an individual or an organization that has products, services, and/or activities that the abandoning consumer may be asked to interact with to receive the incentive redeemable with the abandoned on-line retailer. The offer site provider may be unaffiliated with the on-line retailer. An offer site may be a Web-based interface through which the abandoning consumer may be asked to interact with the offer site provider. A Web-based content provider may be any other Web-based content provider that an on-line consumer may choose to visit, and which is not associated with the on-line retailer or the offer site provider. A remarketing provider may be an individual or an organization that presents abandonment offers to an abandoning consumer. An abandonment offer may comprise data representing the incentive redeemable by an abandoning consumer with the abandoned on-line retailer, data representing an action for an abandoning consumer to complete in order to receive the incentive, graphics, text, and/or advertisements. The on-line retailer and the offer site provider may be clients of the remarketing provider. An incentive may be a coupon, certificate, product, gift card, or other inducement that is used to entice an abandoning consumer to perform a requested action. An incentive coupon may be a tangible coupon, certificate, gift card, or an electronic code redeemable with the on-line retailer for the incentive. A save window may be a pop-up, pop-under or other online method used for presenting an abandonment offer to an abandoning consumer. A fulfillment system may be a server or service that can store inventory details about incentives, incentive coupons and other electronic and/or physical goods. The fulfillment system may receive electronic messages from the remarketing provider and may provide details about a particular incentive coupon or good to an abandoning consumer, on-line retailer, or the remarketing provider.

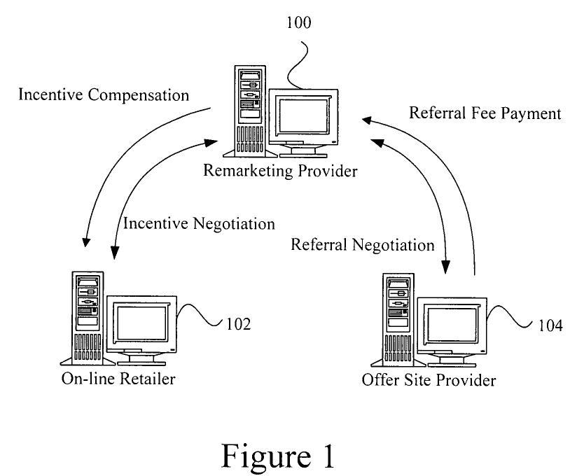

FIG. 1 shows a flow diagram of contracting for abandonment remarketing services in one embodiment of an abandonment remarketing system. When implementing the abandonment remarketing system, a remarketing provider 100 may establish a relationship with an on-line retailer 102 and/or an offer site provider 104. In establishing a relationship, the remarketing provider 100 may negotiate a number of contractual agreements. These contractual agreements may be negotiated through a back and forth process, which may occur through personal, electronic, and/or other communication methods. In some abandonment remarketing methods, the remarketing provider 100 may contact an on-line retailer 102 by telephone to inquire whether the on-line retailer 102 wants to implement the abandonment remarketing method. Alternatively, the remarketing provider 100 may visit the on-line retailer's 102 office, or transmit an electronic message to the on-line retailer 102 to negotiate one or more contractual agreements. Similar types of communications may occur between the remarketing provider 100 and an offer site provider 104. In some abandonment remarketing methods, the on-line retailer 102 and/or the offer site provider 104 may initiate communications with the remarketing provider 100 to implement and/or participate in the abandonment remarketing method. The negotiations related to contractual agreements between the remarketing provider 100 and the on-line retailer 102, and/or the remarketing provider 100 and the offer site provider 104 may be performed concurrently or separately.

One contractual agreement that may be negotiated between the remarketing provider 100 and the on-line retailer 102 may be an incentive agreement. The incentive agreement may comprise an incentive, redeemable with the on-line retailer, which will be offered by the remarketing provider 100 to an abandoning consumer. In some situations, the incentive may be a credit for a set dollar amount, such as $10.00 dollars, which may be deducted from a future purchase. In other situations, the incentive may be a credit for a percentage off of a future purchase, such as a 10% credit. In yet other situations, the incentive may be a complimentary product and/or service. In some incentive agreements, the remarketing provider 100 may agree to compensate the on-line retailer 102 an amount equal to the incentive. In other incentive agreements, the remarketing provider 100 may agree to compensate the on-line retailer 102 at a reduced value of the incentive, such as $5.00 of a $10.00 credit. The time period in which the remarketing provider 100 compensates the on-line retailer 102 for the discount may also be negotiated.

One contractual agreement that may be negotiated between the remarketing provider 100 and the offer site provider 104 may be a referral agreement. The referral agreement may comprise a referral fee which may be paid to the remarketing provider 100 if an abandoning consumer, directed to an offer site by the remarketing provider 100, completes one or more actions at the offer site. The types of activity that the abandoning consumer may be asked to perform at the offer site may comprise purchasing a product or service from the offer site provider 104, and/or providing data corresponding to information requested by the offer site provider 104. The information may be collect by the offer site provider 104 through a graphical user interface such as a formatted document containing blank fields that the abandoning consumer completes with data. In some situations, the information requested by the offer site provider 104 may relate to a product or service sold by the offer site provider 104. In other situations, the information requested by the offer site provider 104 may relate to data that will be used to analyze an aspect or a group or an area, such as a survey. In yet other situations, the information requested by the offer site provider 104 may be personal information that identifies the abandoning consumer.

In some methods of implementing an abandonment remarketing system, compensation for the incentive and/or referral fee may not occur until after an abandoning consumer has completed one or more actions at an offer site. In other methods of implementing an abandonment remarketing system, compensation for the incentive and/or referral fee may not occur until the offer site provider 104 transmits data to the remarketing provider 100 indicating that the abandoning consumer completed one or more actions at the offer site, and/or a predetermined time period has expired. The predetermined time period may represent a billing cycle or any other agreed upon time period. In yet another method of implementing an abandonment remarketing system, compensation for the incentive and/or referral fee may not occur until after an abandoning consumer has completed one or more actions at an offer site, and/or the offer site provider 104 and/or the remarketing provider 100 determine that the one or more completed actions were validly completed by the abandoning consumer.

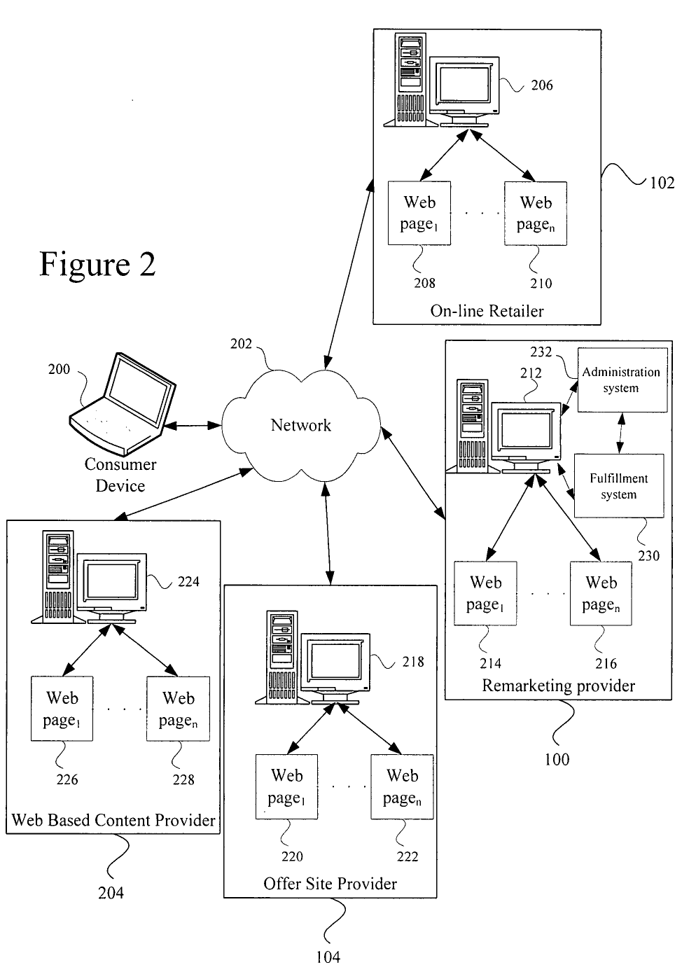

FIG. 2 is a block diagram of an exemplary abandonment remarketing system. In FIG. 2, a consumer device 200 may comprise a stand-alone computer or controller suitable for executing various computer applications and which may support Web browsers and/or graphic interfaces. The consumer device 200 may be coupled with a network 202. The on-line retailer 102, the remarketing provider 100, the offer site provider 104, and a Web-based content provider 204 are also coupled to the network 202.

The network 202 may be enabled to employ any form of machine-readable media for communicating information from one device to another and may include any communication method by which information may travel between devices. The network 202 may include one or more of a wireless network, a wired network, a local area network (“LAN”), a wide area network (“WAN”), and may include the set of interconnected networks that make up the Internet. The wireless network may be a cellular telephone network, operating according to a standardized system such as Global System for Mobile Communications (“GSM”), Code Division Multiple Access (“CDMA”), 3G mobile communications technology; a network operating according to a standardized protocol such as IEEE 802.11, 802.16, 802.20, 802.x, published by the Institute of Electrical Engineers, Inc.; and/or a WiMax network. The network 202 may be a public network, such as the Internet, or combinations thereof, and may utilize a variety of networking protocols now available or later developed including, but not limited to Transfer Control Protocol/Internet Protocol (“TCP/IP”) based networking protocols. The network 202 may be a private, digital content network, such as a cable television provider or a satellite television provider.

The consumer device 200 may include an interface for a consumer to access the network 202 and exchange data with an on-line retailer Web server 206, a remarketing provider Web server 212 (e.g., an abandonment Web server), an offer site Web server 218, and/or a Web-based content provider Web server 224. The user of the consumer device 200 may be a consumer of goods or services that is requesting information from, sending information to, or conducting a transaction on, a Web site or other web connected entity. Alternatively, a user may include a business entity or group of people, rather than an individual person.

Each of the on-line retailer Web server 206, the abandonment server 212, the offer site Web server 218, and the Web-based content provider Web server 224 represent different servers that the consumer device 200 may access. The on-line retailer Web server 206 may be associated with a first Web site or a first domain, the abandonment server 212 may be associated with a second Web site or a second domain, the offer site Web server 218 may be associated with a third Web site or a third domain, and the Web-based content provider Web server 224 may be associated with a fourth Web site or a fourth domain. Each of the on-line retailer Web server 206, the offer site Web server 218, and the Web-based content provider Web server 224 may comprise a computer or a group of independent network servers that operate, and appear to the user, as if they were a single unit. Each of the on-line retailer Web server 206, the offer site Web server 218, and the Web-based content provider Web server 224 may comprise one or more programs that provide time sharing and data management, provide multi-user functionality, support persistent and/or non-persistent connections with the consumer device 200, and/or provide various firewall or other security measures. The logic and programming of each of the on-line retailer Web server 206, the offer site Web server 218, and the Web-based content provider Web server 224 may be distributed among multiple computers and other devices, some of which may work independently but also may communicate with other devices that have similar or different operating systems.

Each of the on-line retailer Web server 206, the abandonment Web server 212, the offer site Web server 218, and/or the Web-based content Web server 224 may store data representing one or more Web pages 208-210, 214-216, 220-222, and 226-228, respectively. Some or all of the Web pages 208-210, 214-216, 220-222, and 226-228 may comprise information providing a short text message or graphical representation summarizing a product or service for sale, as well as an associated price. The data representing the Web pages 208-210, 214-216, 220-222, and 226-228 may be stored in a Hyper Text Markup Language (“HTML”) file, Extensible Markup Language (“XML”) file, and/or other content storage format used to create documents that are viewable through a Web browser. For simplicity, only one remarketing provider 100, on-line retailer 102, offer site provider 104, and Web-based content provider 204 are shown in FIG. 2; however more than one of these entities are contemplated.

A fulfillment system 230 may be in communication with or integral to the abandonment Web server 212. The fulfillment system 230 may comprise a processor and a memory space that stores a listing of available incentives (e.g., an incentive inventory comprising one or more incentives and/or incentive coupons) and/or personal identifiable information about an abandoning consumer. When an abandoning consumer completes an action at an offer site or when the abandoning consumer completes an action at an offer site and the offer site and/or the abandonment server validate the completion of the action, the fulfillment system 230 may receive personal identifiable information about the abandoning consumer. The personal identifiable information may comprise an abandoning consumer's name, email address, postal address, telephone number, financial information, and/or other personal characteristics. The fulfillment system 230 may associate some or all of the received personal identifiable information with the incentive inventory, and/or update its inventory records. The remarketing provider may supply the on-line retailer with inventory data, such as a listing of assigned incentives, assigned incentive coupons, and/or associated personal identifiable information. This inventory data may be supplied to the on-line retailer prior, concurrent, or subsequent to the time that the remarketing provider compensates the on-line retailer for assigned incentives or assigned incentive coupons.

An administration system 232 may be in communication with or integral to the abandonment Web server 212. The administration system 232 may be used by the remarketing provider 100 to configure the abandonment remarketing system. Access to the administration system 232 may be restricted to users through security features that require entry of a username and password or other security credentials. Through the administration system 230, the remarketing provider may be able to view a listing of on-line retailers 102 and offer site providers 104 that are participating in the abandonment remarketing method. The remarketing provider 100 may use the administration system 232 to add new on-line retailers and/or offer site provides to the abandonment remarketing system. Adding a new on-line retailer to the abandonment remarketing system may comprise generating one or more abandonment offer files associated with the new on-line retailer, and/or generating source code that will be used with the new on-line retailer's Web pages that are to be abandonment remarketing eligible Web pages. Additionally, the administration system 232 may be used to modify an abandonment offer file associated with a particular on-line retailer, and/or generate abandonment remarketing reports.

The abandonment Web server 212 may comprise a computer or a group of independent network servers that operate, and appear to the consumer, as if they were a single unit. The abandonment server 212 may include a memory that stores abandonment logic, remarketing logic, incentive data representing an incentive redeemable with an on-line retailer, Web page address data (e.g., Uniform Resource Locator (“URL”) linking data) of an offer site whose operators have entered into a referral agreement with the remarketing provider, graphic and/or text advertisement data, and/or offer presentation logic. Some or all of this information may be stored in an abandonment offer file. In some abandonment Web servers 212 there may be one abandonment offer file that corresponds to each combination of abandonment logic, incentive data, offer site URL data, graphic and/or text advertisement data, and/or offer presentation logic.

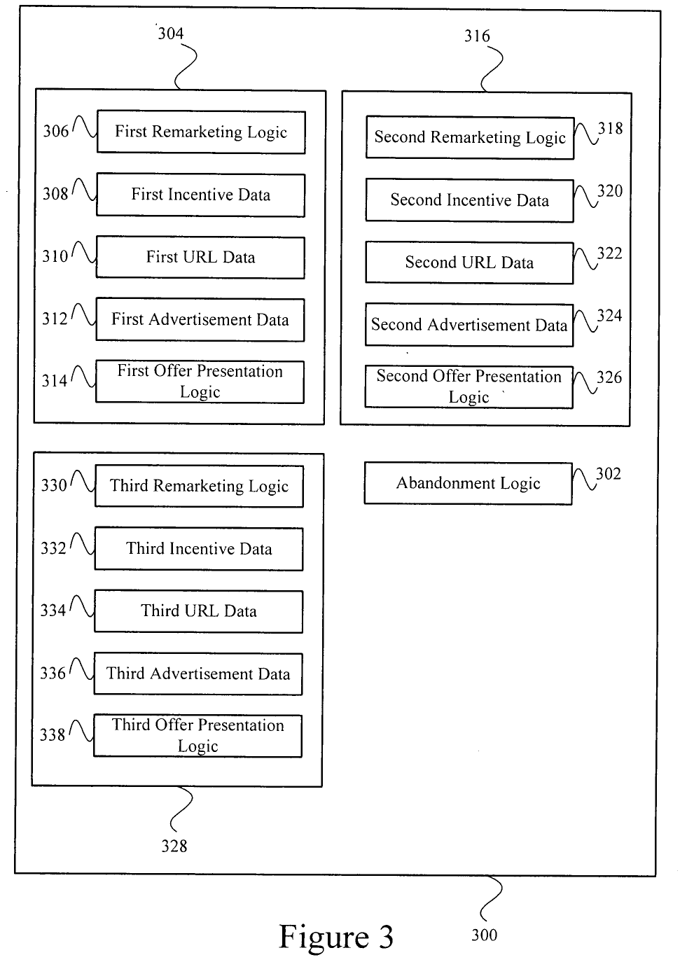

FIG. 3 is a diagram of a memory space in the abandonment Web server 212. In FIG. 3, the memory 300 stores abandonment logic 302, a first abandonment offer file 304, a second abandonment offer file 316, and a third abandonment offer file 328. The abandonment logic 302 may be a common file accessible to multiple different on-line retailers. The conditions of the abandonment logic 302 may be configured by an on-line retailer or the remarketing provider 102.

The first, second, and third abandonment offer files 304, 316, and 328, respectively, may contain data used to present an abandonment offer to an abandoning consumer. These files may be specific to one or more on-line retailers. For example, the first and second abandonment offer files 304 and 316 may be configured for use with a first on-line retailer. Each abandonment offer file may comprise different data such that a consumer that abandons an eligible Web page of the first on-line retailer may be presented with different incentives redeemable with the first on-line retailer, different actions to complete at an offer site, different offer site, and/or different advertisements. The third abandonment offer file 328 may be configured for use with a second on-line retailer offering an incentive, and where the remarketing provider 100 has determined that which offer site URL will be presented to an abandoning consumer. Although FIG. 3 only shows three abandonment offer files, there may be one abandonment offer file for each on-line retailer that has entered into an incentive agreement with the remarketing provider, and/or one abandonment offer file for each configuration of an abandonment offer that may be presented to an abandoning consumer.

The abandonment logic 302 may determine when a consumer abandons an on-line retailer Web page 208-210 based on the occurrence of an abandonment action. An abandonment action may include the consumer closing a Web browser window displaying an on-line retailer Web page 208-210, following a hypertext link to another Web page unaffiliated with the on-line retailer, entering in the Web browser's location bar or bookmark system a URL unaffiliated with the on-line retailer, and/or using the Web browser's navigation controls to “back out” of the on-line retailer Web page 208-210 to browse a Web page unaffiliated with the on-line retailer. Additionally, the abandonment logic 302 may be configured to classify certain actions as non-abandonment actions. Non-abandonment actions may include transitioning from one Web page within the on-line retail site to another Web page within the on-line retail Web site, or following a hypertext link provided by the on-line retailer to another Web page unaffiliated with the on-line retail site.

The first abandonment offer file 304 may comprise first remarketing logic 306, first incentive data 308, first URL data 310, first advertising data 312, and/or first offer presentation logic 314. The first remarketing logic 306 may determine whether an abandonment offer should be presented to a consumer that abandons an on-line retailer's abandonment remarketing eligible Web page. For example, the remarketing logic 306 may determine that an abandonment offer should be presented to a consumer abandoning a Web page of a first on-line retailer when the consumer leaves an eligible Web page that has specific text in the body of the Web page, or when the consumer leaves an eligible Web page that has a specific pattern in the Web page's URL. Additionally, the remarketing logic 306 may determine that an abandonment offer should not be presented to an abandoning consumer when the consumer was directed to the current active eligible Web page from a specific external source, such as a paid search advertisement, or when the abandoning consumer is following a hypertext link, on an eligible Web page, provided by the on-line retailer 102. The conditions for the first remarketing logic 306 may be configured by the remarketing provider 100, and may be configured based on input from the on-line retailer to which the first abandonment offer file corresponds.

The first incentive data 308 may represent a first incentive with a first on-line retailer. For example, the first incentive data 308 may represent a discount of $10. The first URL data 310 may represent a link to a first offer site. The first advertising data 312 may comprise graphics and/or text associated with the first on-line retailer and/or the first offer site, such as logos and/or a short text string. The first offer presentation logic 314 may comprise formatting information that specifies how the first incentive data 308, the first URL data 310, and/or the first advertising data 312 may be presented in an abandonment offer to an abandoning consumer.

In FIG. 3 a second abandonment offer file 316 comprises a second remarketing logic 318, a second incentive data 320, a second URL data 322, a second advertising data 324, and/or a second offer presentation logic 326. The second remarketing logic 318 may comprise the same logic as the first remarketing logic 306 or may comprise different logic to determine when an abandonment offer should or should not be presented to a consumer abandoning an abandonment eligible Web page. The second discount data 320 may represent a second amount of credit redeemable at the first on-line retail site, such as 20%. The second URL data 322 may represent a link to a second offer site. The second advertising data 324 may comprise graphics and/or text associated with the first on-line retailer and/or the second offer site. The second offer presentation logic 326 may comprise formatting information that specifies how the second discount data 320, the second URL data 322, and/or the second advertising data 324 may be presented in an abandonment offer to an abandoning consumer.

FIG. 3 also shows a third abandonment offer file 328. The third abandonment offer file 328 comprises third remarketing logic 330, third incentive data 332, third URL data 334, third advertising data 336, and/or third offer presentation logic 336. The third remarketing logic 326 may be configured by a second on-line retailer and/or the remarketing provider 100 to determine when an abandonment offer should or should not be presented to a consumer abandoning an abandonment eligible Web page of the second on-line retailer. The third incentive data 330 may represent an amount of credit redeemable at the second on-line retail site. The third URL data 334 may represent a link to a third offer site. The third advertising data 336 may comprise graphics and/or text associated with the second on-line retailer and/or the third offer site. The third offer presentation logic 338 may comprise formatting information that specifies how the third discount data 332, the third URL data 334, and/or the third advertising data 336 may be presented to an abandoning consumer.

The remarketing provider 100 may determine the URL data, advertising data, and/or offer presentation logic used in any of the abandonment offer files stored in the memory 300 of the abandonment server 212. The contents of an abandonment offer file may be changed or updated by the remarketing provider 100 without any action by an on-line retailer. In some abandonment remarketing systems, the incentive and/or offer site included in an abandonment offer may be assigned in a static manner by the remarketing provider. In other abandonment remarketing systems, selection logic may be used to dynamically select the incentive from a pool of incentives, the URL data from a pool of offer site providers, and/or advertisement data from a pool of graphics and/or text stored on the abandonment server or a database in communication with the abandonment server. The dynamic selection may be based on an area of the on-line retailer where an abandonment action occurred, on consumer demographics, time of day, online consumer behavior, such as session information found in the abandoning consumer's Web browser, and/or other Web page content. The dynamically selected data may be inserted into an abandonment offer file manually or through an automated process for use with the abandonment remarketing system. The data comprising the abandonment offer file may be managed by the remarketing provider through the administration system 232.

The abandonment offer files 304,316, and/or 328 may be formatted according to JavaScript® and/or other client-side technology files. In some abandonment remarketing systems, the abandonment logic 302 may be integral to an abandonment offer file, such as the first, second, and/or third abandonment offer file 304, 316, and 328, respectively. In other abandonment remarketing systems, some or all of the files stored in memory, either separately or integrated together, may be stored in a database which may be in communication the abandonment server 212.

The on-line retailer Web server 206 may include a memory which may store save window logic. The save window logic may be stored under the same domain name that serves the on-line retail Web pages, and may invoke the offer presentation logic stored on the abandonment server to generate an abandonment offer when a consumer abandons an eligible on-line retailer Web page 208-210. For example, when a consumer leaves an eligible Web page or closes the Web browser that was previously displaying an eligible Web page, the Web browser may execute the save window logic. The save window logic may analyze the content of the new Web page, determine that the consumer has closed the Web browser, analyze one or more cookie files stored on the consumer device 200, and/or cause the abandonment server to serve some or all of the data stored in an abandonment offer file. The save window logic may process some or all this data to determine that the consumer has abandoned the eligible Web page, and may cause a save window Web browser window to appear on the consumer's consumer device 200. The save window may comprise the abandonment offer, which may include a description of an incentive available to the abandoning consumer, a description of the action to be completed at an offer site, a link to the offer site, and/or additional advertising information. In some situations, the save window logic may determine that the consumer did not abandon the on-line retail site, such as when the consumer moved to another Web page of the on-line retailer's site, or that the consumer has already seen too many abandonment offers. In these or other non-abandonment situations, the save window logic may suppress an abandonment offer. The save window logic may include data that is stored in a HTML file, a JavaScript® file, a Flash file, a Visual Basic (“VB”) Script file, and/or other developed client-side technology files.

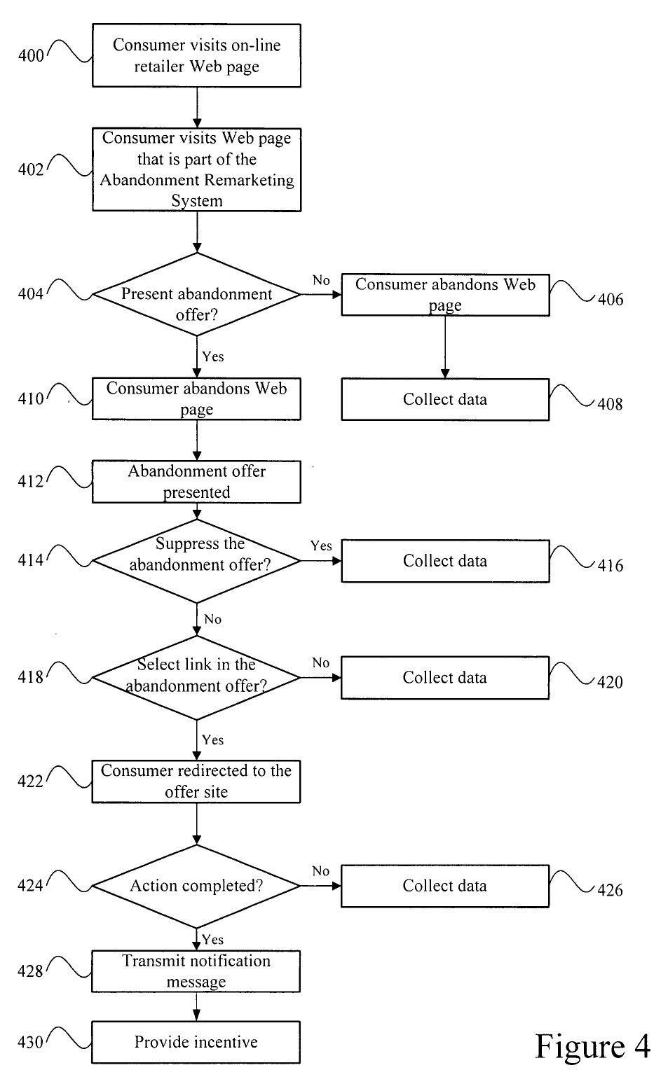

FIG. 4 is a flow diagram to retain on-line business. At act 400 a consumer visits an on-line retailer Web page. The consumer may have entered the on-line retailer's URL into a Web browser location bar, or may have been redirected to the on-line retailer's Web page from an external source. At act 402, the consumer visits a Web page of the on-line retailer that is part of the abandonment remarketing system (e.g., an eligible Web page). In some instances, all of the on-line retailer's Web pages may be eligible Web pages. Alternatively, the on-line retailer may designate a subset of its Web pages as eligible Web pages.

At act 404, a decision is made whether an abandonment offer should be presented if the consumer abandons the current Web page. Because the Web page is an eligible Web page, as the Web page is loaded the Web browser will source the identified abandonment offer file stored on the abandonment Web server. As the Web page loads, the remarketing logic may analyze various Web page information, such as the address of the Web page, the contents of the Web page, a time and/or date, and/or consumer information that may be stored in a text file, such as a cookie, to determine if an abandonment offer should be generated if the consumer abandons the Web page.

At act 406, the consumer abandons the on-line retailer's eligible Web page for which the remarketing logic has determined that an abandonment offer should not be presented. At act 408, data representing the time, date, location of the on-line retailer Web page where the abandonment occurred, and/or the type of abandonment action may be collected. The data collected at act 408 may be processed (in batches or in real or near real time) at the abandonment server or another processing device in communication with the abandonment server in order to generate one or more analysis reports. The analysis reports may comprise a conversion volume snapshot, a daily conversion trend, monthly conversion trend, and/or payment summaries. These reports may further comprise data representing how many times a particular incentive and/or offer site URL was included in an abandonment offer, how many times an abandonment offer was presented to abandoning consumers, how many times the save window's logic suppressed the abandonment offer, how many times an abandoning consumer clicked on a link to an offer site, and/or other metrics related to the operation of the abandonment remarketing system. These analysis reports may be reviewed by the remarketing provider, an on-line retailer, and/or other individuals and/or organizations interested in recovering abandoning on-line consumers.

At act 410, a consumer abandons the on-line retailer's eligible Web page for which the remarketing logic has determined that an abandonment offer should be presented. At act 412, data representing an abandonment offer is served from the abandonment server to the abandoning consumer's Web browser. At act 414, the abandoning consumer's Web browser presents or suppresses an abandonment offer comprising the data served from the abandonment server in accordance with the save window logic stored on the on-line retailer's Web server. If the abandonment offer is suppressed, data representing the time, date, location of the on-line retailer Web page where the abandonment occurred, and/or the type of abandonment action may be collected at act 416. This collected data may be processed and/or analyzed as previously discussed. If the abandonment offer is not to be suppressed, an abandonment offer may be presented to the abandoning consumer. The abandonment offer may comprise a Web page that is a save window on the abandoning consumer's consumer device. The abandonment offer may further comprise information describing the incentive with the on-line retailer, a description of an action to be performed at an offer site Web site, and/or a hypertext link to the offer site Web page. For example, the incentive may be a credit of a fixed dollar amount or percentage which may be applied to a future purchase from the on-line retailer. The action may require the abandoning consumer to purchase a product or service from an offer Web site. Alternatively, the action may require the abandoning consumer to submit survey feedback and/or enroll for a service offered by an offer Web site.

At act 418 it may be determined whether the abandoning consumer followed the hypertext link included in the abandonment offer. If the abandoning consumer does not select the hypertext link, data representing the time, date, discount presented, and/or other user or Web page information may be collected at act 420. The data collected at act 420 may be processed at the abandonment server or another processing device in communication with the abandonment server in order to generate one or more analysis reports, as previously discussed. These analysis reports may be reviewed by the remarketing provider, the on-line retailer, and/or other individuals and/or organizations interested in recovering abandoning on-line consumers.

If the abandoning consumer selects the hypertext link at act 418, the abandoning consumer is redirected to an offer site Web page at act 422 where an action is presented to the abandoning consumer. The abandoning consumer may be redirected to the offer site Web page in the same Web browser window that displayed the abandonment offer. Alternatively, a new Web browser window may be opened in which the offer site Web page is displayed.

At act 424 it is determined if the abandoning consumer completed the action presented on the offer site Web page. The action may comprise purchasing a product or service, providing data corresponding to information requested by the offer site provider, and/or collecting data for the analysis of some aspect of a group or area. If the abandoning consumer exits the offer site Web page without completing the action, data representing the time, date, portion of the offer site Web page may be collected at act 426. The data collected at act 426 may be collected by the remarketing provider and/or the offer site provider. If the offer site provider collects the data at act 426, the offer site provider may make this data available to the remarketing provider. The data collected at act 426 may be processed to generate one or more analysis reports, as previously discussed. These analysis reports may be reviewed by the remarketing provider, the offer site provider, and/or other individuals and/or organizations interested in recovering abandoning on-line consumers.

By completing the action on the offer site Web page, data related to the abandoning consumer may be collected. This data may comprise personal identifiable information. The data may be collected directly by the offer site provider, or may be collected by the remarketing provider. The collected data may be used to provide the abandoning consumer with the purchased product or service or data for which the abandoning consumer enrolled. If the abandoning consumer completes the action at act 424, a completion notification message may be transmitted to the remarketing provider.

In some abandonment remarketing systems, after the abandoning consumer completes the requested action, the offer site provider may validate the information supplied by the abandoning consumer to determine if the supplied information is authentic or if the abandoning consumer has previously completed the action requested by the offer site. Validation of the data may comprise comparing the data submitted by the abandoning consumer to data stored in one or more databases accessible to the offer site provider, such as a listing of current individuals or corporations already affiliated with the offer site, financial institutions, credit bureaus, and/or government agencies. When the offer site provider validates the information supplied by the abandoning consumer, the notification message may include validity data indicating that the abandoning consumer provided authentic data.

At act 428, a completion notification message may be transmitted from the offer site provider to the remarketing provider. The notification message may contain some or all of the data collected in response to abandoning consumer completing the offer site action and/or validity data.

If the offer site validates the information supplied by the abandoning consumer and the supplied information matches information obtained through the validation procedure, the remarketing provider receives validity data and provides the abandoning consumer with the incentive that was presented in the abandonment offer at act 430. At act 430, the abandonment server may retrieve the details of an incentive coupon and/or may submit an order for a physical coupon, certificate, and/or gift certificate through a data exchange with the fulfillment system. For example, the remarketing provider may transmit through an electronic mail message, web service message, or other electronic data exchange method the contact information for the abandoning consumer so that the fulfillment system may transmit the incentive coupon details to the abandoning consumer so that the consumer may redeem the coupon with the on-line retailer for the presented incentive. Alternatively, the fulfillment system may use the transmitted details to physically deliver the incentive to the abandoning consumer through the postal service or a commercial delivery service. The abandonment server may also request the fulfillment system to deliver the incentive coupon details back to the abandonment server so that the incentive coupon details may be passed back to the offer site in the form of a redemption URL that may direct the abandoning consumer's Web browser back to the on-line-retailer site in such a way that the incentive coupon is applied to the abandoning consumer's order with the online-retailer or to a shopping cart order screen. The offer site may display this URL to the abandoning consumer in a Web page, or the offer site may automatically redirect the abandoning consumer's web browser to the redemption URL. After the fulfillment system transmits the incentive coupon details to the abandoning consumer or the abandonment server, the fulfillment may update the incentive inventory or otherwise track the assignment of the incentive.

After the incentive has been presented to the abandoning consumer, the remarketing provider and the offer site provider may execute a transaction where the offer site provider pays the remarketing provider the referral fee. The payment may be made by electronic funds transfer, check, cash, wire transfer, and/or other financial exchanges. In some instances, the offer site provider will make a referral fee payment after each abandoning consumer completes an action on the offer site, or after each abandoning consumer's supplied data has been validated. Alternatively, the offer site provider may make a lump referral fee payment comprising payment for multiple abandoning consumers that have completed an action on the offer site or after each abandoning consumer's supplied data has been validated. The lump payment may be made at the conclusion of a predetermined time period, such as a billing cycle.

After the remarketing provider supplies the incentive to the abandoning consumer, the remarketing provider and the on-line retailer may execute a transaction where the remarketing provider compensates the on-line retailer an amount equal to or less than the amount of the incentive. The compensation to the on-line retailer may be made by electronic funds transfer, check, cash, wire transfer, and/or other financial exchanges. In some instances, the remarketing provider may execute a transaction to compensate the on-line retailer for an incentive after each abandoning consumer completes an action on the offer site, or after each abandoning consumer's supplied data has been validated. Alternatively, the remarketing provider may execute a lump transaction to compensate an on-line retailer for multiple incentives after each abandoning consumer's supplied data has been validated. The lump transaction may be made at the conclusion of a predetermined time period, such as a billing cycle.

Data transmitted between the abandonment server, the on-line retailer, the offer site provider, and/or the abandoning consumer's Web browser may be transmitted by electronic mail messages having any of a number of known formats. Additionally, data may be transmitted between the abandonment server, the on-line retailer, the offer site provider, and/or the abandoning consumer's Web browsers according to Simple Object Access Protocol (“SOAP”), Extensible Market-Language Remote Procedure Call (“XML-RPC”) or Representative State Transfer (“REST”) web service calls through HTTP or Hyper-Text Transfer Protocol Secure (“HTTPS”); remote procedure calls through Common Object Request Broker Architecture (“CORBA”), Distributed Component Object Model (“DCOM”) or other standardized RPC methods; batch data transfers through File Transfer Protocol (“FTP”) (or other batch transfer protocols) of database Standard Query Language (“SQL”) dumps, XML files, Comma Separated Value (“CSV”) files or other serialized forms of data. Data received by the abandonment server may be stored in serialized form (CSV, XML, SQL dumps, etc.) on the abandonment server's file system, in a relational database in communication with the abandonment server, or any other common storage mechanism.

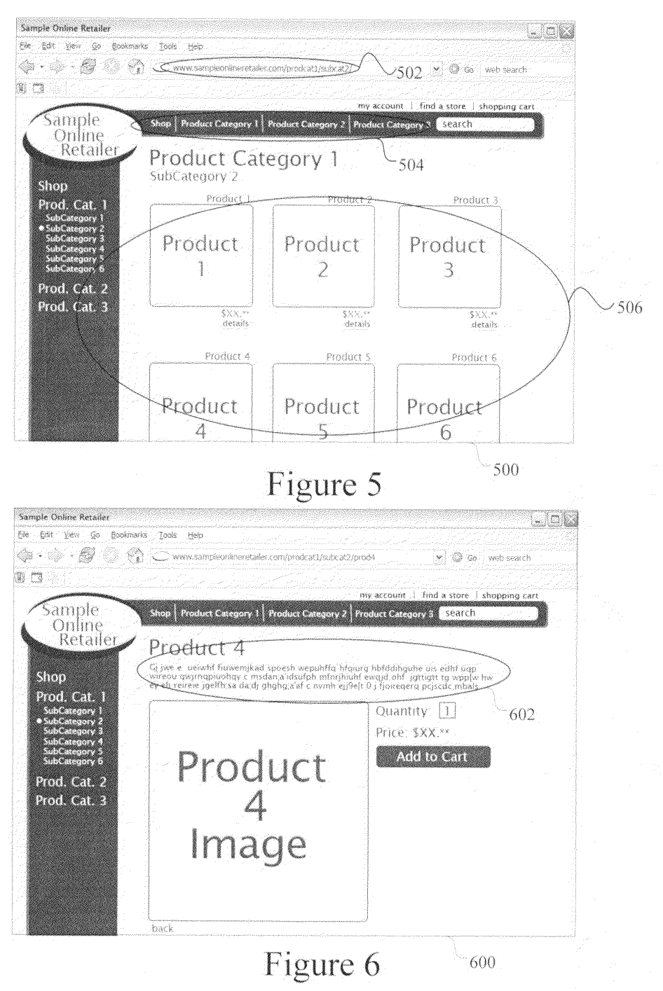

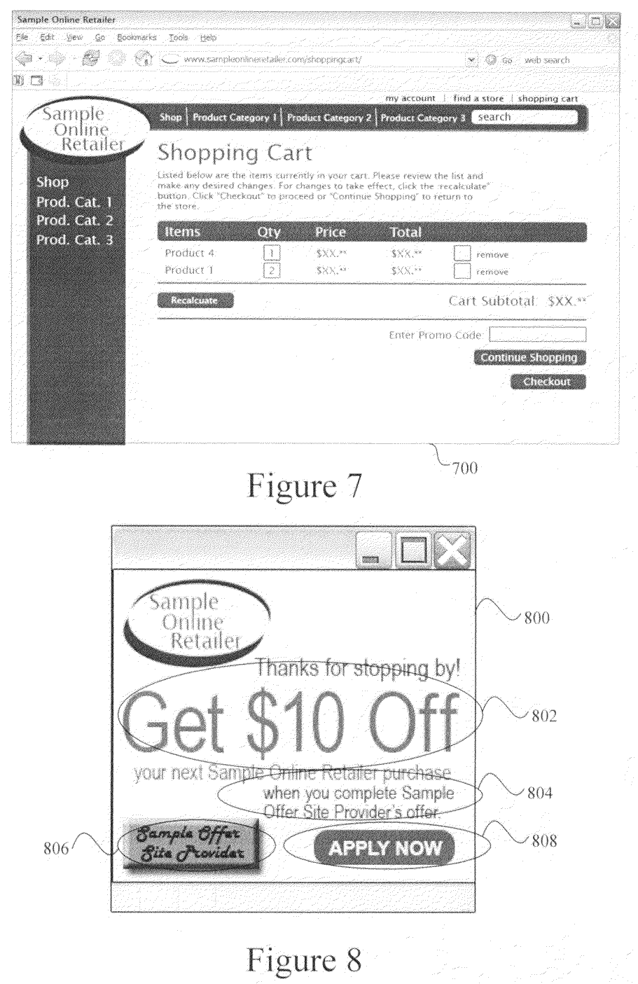

FIGS. 5-7 are examples of graphic user interfaces of an on-line retailer. In FIG. 5, a graphic user interface 500 delivers information about products offered for sale by an on-line retailer. A URL address of the on-line retailer is provided in a location bar 502. Hypertext links 504 enable a consumer to browser other Web pages of the on-line retailer. The graphic user interface 500 also includes graphic representations of products 506 that may be purchased from the on-line retailer. In FIG. 6, a graphic user interface 600 accessed from the first graphic user interface 500 includes a short text message 602 providing an additional description about a product offered for sale by the on-line retailer. In FIG. 7, a graphic user interface 700 shows an interface that allows an on-line consumer to select merchandise for purchasing, review selected merchandise, make modifications, additions, and/or deletions to selected merchandise, and/or purchase the selected merchandise. Any of the graphic user interfaces of FIGS. 5-7 may be selected to be part of an abandonment remarketing system.

If a consumer decides to leave an abandonment remarketing eligible Web page of the on-line retailer, the on-line retailer becomes an abandoned on-line retailer, and as described in FIG. 4, the abandonment server presents and delivers an abandonment offer in a graphic interface such as shown in FIG. 8. This graphic user interface 800 presents incentive data 802 for an abandoned retailer. Additionally, this graphic interface 800 may show an action 804 to be performed at an offer site. This graphic interface 800 may also show an advertisement 806 for the offer site provider, and a hypertext link 808 that may redirect the abandoning consumer to the offer site.

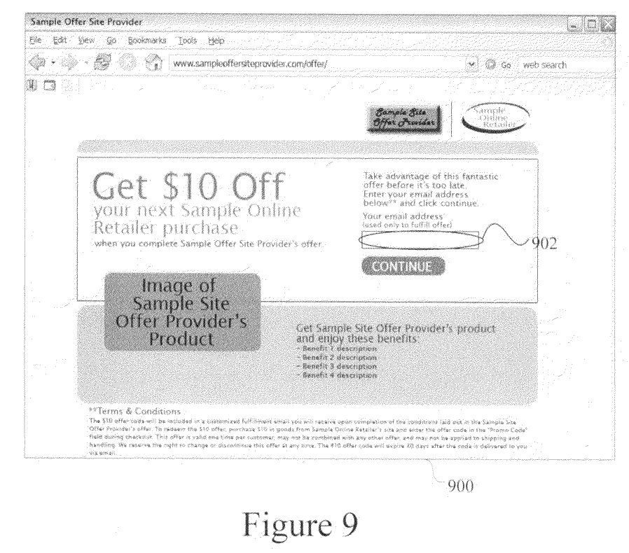

FIG. 9 is an example of a graphic interface of an offer site that the abandoning consumer is redirected to after clicking on the hypertext link 808 in FIG. 8. The graphic user interface 900 includes a field 902 for an abandoning consumer to input an electronic mail address. The electronic mail address may be used to provide the abandoning consumer, upon completing the identified action, with an incentive code which may represent the incentive redeemable at the abandoned on-line retailer. The graphic user interface 900 may link to additional Web pages which may contain one or more fields used to receive data input by the abandoning consumer.

The processes described may be encoded in a signal-bearing medium, a computer readable medium such as a memory, programmed within a device such as one or more integrated circuits, or one or more processors, or may be processed by a controller or a computer. If the processes are performed by software, the software may reside in a memory resident to or interfaced to a storage device, a communication interface, or non-volatile or volatile memory in communication with a transmitter. The memory may include an ordered listing of executable instructions for implementing logical functions. A logical function or any system element described may be implemented through optic circuitry, digital circuitry, through source code, through analog circuitry, or through an analog source, such as through an electrical, audio, or video signal. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine-readable medium,” “propagated-signal” medium, and/or “signal-bearing medium” may comprise any device that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection having one or more wires, a portable magnetic or optical disk, a volatile memory such as a Random Access Memory “RAM,” a Read-Only Memory “ROM,” an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

Although selected aspects, features, or components of the implementations are depicted as being stored in memories, all or part of the systems, including processes and/or instructions for performing processes, consistent with the system may be stored on, distributed across, or read from other machine-readable media, for example, secondary storage devices such as hard disks, floppy disks, and CD-ROMs; a signal received from a network; or other forms of ROM or RAM, some of which may be written to and read from in a vehicle.

Specific components of a system may include additional or different components. A controller may be implemented as a microprocessor, microcontroller, application specific integrated circuit (ASIC), discrete logic, or a combination of other types of circuits or logic. Similarly, memories may be DRAM, SRAM, Flash, or other types of memory. Parameters (e.g., conditions), databases, and other data structures may be separately stored and managed, may be incorporated into a single memory or database, or may be logically and physically organized in many different ways. Programs and instruction sets may be parts of a single program, separate programs, or distributed across several memories and processors.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A method of retaining business for an on-line retailer, comprising:
receiving incentive data from an on-line retailer, the incentive data representing an incentive redeemable with the on-line retailer;
presenting an abandonment offer to a consumer that abandons a Web page operated by the on-line retailer, the abandonment offer comprising a description of the incentive that the abandoning consumer will receive in exchange for completing an action at an offer site and a link to the offer site;
receiving notification that the abandoning consumer completed the action at the offer site;
issuing an incentive coupon to the abandoning consumer, the incentive coupon redeemable with the on-line retailer for the incentive;
receiving a referral fee payment from the offer site; and
executing a transaction with the on-line retailer as compensation for the incentive.

2. The method of claim 1, where the incentive coupon comprises one of a coupon, certificate, or gift card.

3. The method of claim 1, where the incentive coupon comprises a code.

4. The method of claim 1, where presenting an abandonment offer to the consumer that abandons the predetermined Web page operated by the on-line retailer comprises serving a save window viewable by the abandoning consumer.

5. The method of claim 1, where the description of the incentive that the abandoning consumer will receive in exchange for completing an action at the offer site is dynamically selected based on a content of the abandoned Web page.

6. The method of claim 1, where the description of the incentive that the abandoning consumer will receive in exchange for completing an action at the offer site is dynamically selected based on session information received from the abandoning consumer's Web browser.

7. The method of claim 1, where the action to be completed at the offer site is dynamically selected based on a content of the abandoned Web page.

8. The method of claim 1, where the action to be completed at the offer site is dynamically selected based on session information found in the abandoning consumer's Web browser.

9. The method of claim 1, where the act of issuing the incentive coupon to the abandoning consumer comprises transmitting an electronic mail message through the Internet.

10. The method of claim 1, further comprising re-directing the abandoning consumer to a Web page operated by the on-line retailer after completion of the action at the offer site.

11. The method of claim 10, where the act of re-directing the abandoning consumer back to the on-line retailer after completing the action at the offer site occurs automatically.

12. The method of claim 1, further comprising generating an abandonment offer report, the abandonment offer report comprising abandonment offer acceptance data.

13. The method of claim 1, where the act of issuing the incentive coupon to the abandoning consumer comprises transmitting an incentive code to the on-line retailer for display within a shopping cart order screen.

14. A method of retaining on-line retail consumers, comprising:
procuring an incentive from an on-line retailer;
offering the incentive to a consumer that abandons a Web-based interface of the on-line retailer in exchange for the abandoning consumer performing an action at an offer site;
receiving an indication that the abandoning consumer performed the action;
receiving a referral fee payment from the offer site;
reimbursing at least a portion of a cost of the incentive to the on-line retailer.

15. The method of claim 14, where receiving the indication that the abandoning consumer performed the action comprises receiving validity data indicating that the abandoning consumer provided authentic information.

16. The method of claim 14, where performing an action comprises completing a form with personal identifiable information.

17. The method of claim 14, further comprising issuing the incentive to the abandoning consumer.

18. The method of claim 17, further comprising updating an inventory of available incentives.

19. A computer readable storage medium comprising a set of processor executable instructions to execute the following acts:
offering an incentive procured from an on-line retailer to a consumer that abandons a predetermined Web page of the on-line retailer in exchange for the abandoning consumer performing an action at an offer site;
receiving an indication that the abandoning consumer performed the action;
receiving a referral fee payment from the offer site;
reimbursing at least a portion of the cost of the incentive to the on-line retailer.

20. The computer readable storage medium of claim 19 further containing an instruction to present the incentive to the abandoning consumer.
